(19) United States
(12) Patent Application Publication
(10) Pub. No.: US 2025/0314214 A1
(43) Pub. Date: Oct. 9, 2025

(54) METHOD FOR OPERATING AN INTERNAL COMBUSTION ENGINE AN INTERNAL COMBUSTION ENGINE SYSTEM AND A VEHICLE

(71) Applicant: VOLVO PENTA CORPORATION, Göteborg (SE)

(72) Inventors: Stina HEMDAL, Göteborg (SE); Prajwal KAGGANAGADDE, Göteborg (SE)

(73) Assignee: VOLVO PENTA CORPORATION, Göteborg (SE)

(21) Appl. No.: 19/089,340

(22) Filed: Mar. 25, 2025

(30) Foreign Application Priority Data
Apr. 4, 2024 (EP) 24168509.8

(51) Int. Cl. F02D 41/40; F02D 41/00; F02D 41/14; F02D 41/38

(52) U.S. Cl. CPC F02D 41/403; F02D 41/0025; F02D 41/009; F02D 41/1446; F02D 2041/389

(57) ABSTRACT

A method for operating an internal combustion engine includes during and/or prior to an intake phase when at least air is provided into a combustion chamber from a air intake system while a piston is moving from a top dead center to a bottom dead center, injecting a pilot fuel into the air intake system by the pilot fuel injector, and during a compression phase following said intake phase when the piston is moving from the bottom dead center to the top dead center, injecting a primary fuel directly into the combustion chamber by the main fuel injector.

### TECHNICAL FIELD

The disclosure relates generally to internal combustion engines. In particular aspects, the disclosure relates to a method for operating an internal combustion engine, an internal combustion engine system, and a vehicle. The disclosure can be applied to heavy-duty vehicles, such as trucks, buses, and construction equipment, among other vehicle types. The disclosure can also be applied to other vehicles, such as marine vessels. The disclosure can also be applied to stationary internal combustion engines. Although the disclosure may be described with respect to a particular vehicle, the disclosure is not restricted to any particular vehicle.

### BACKGROUND

Internal combustion engines often use gasoline or diesel fuel. However, there is a desire to operate internal combustion engines with more sustainable fuels to thereby reduce the environmental impact. Hence, there is a strive to develop improved technology relating to internal combustion engines which use more sustainable fuels.

### SUMMARY

According to a first aspect of the disclosure, a method for operating an internal combustion engine is provided. The internal combustion engine comprises:
a cylinder and a piston at least partially accommodated by the cylinder, wherein the piston is arranged to reciprocate within and relative to the cylinder between a top dead center and a bottom dead center, said cylinder and said piston at least partially defining a combustion chamber,
an air intake system arranged to provide air into the combustion chamber,
at least one air intake valve arranged to selectively open and close fluid communication between the air intake system and the combustion chamber,
a main fuel injector arranged to inject a primary fuel directly into the combustion chamber,
a pilot fuel injector arranged to inject a pilot fuel into the air intake system, wherein the method comprises:
   during and/or prior to an intake phase when at least air is provided into the combustion chamber from the air intake system while the piston is moving from the top dead center to the bottom dead center, injecting a pilot fuel into the air intake system by the pilot fuel injector, and
   during a compression phase following said intake phase when the piston is moving from the bottom dead center to the top dead center, injecting a primary fuel directly into the combustion chamber by the main fuel injector.

Generally, the pilot fuel is different to the primary fuel. Purely by way of example, the pilot fuel and the primary fuel may have different chemical compositions. For example, the pilot fuel may be a high cetane fuel and the primary fuel may be a low cetane fuel, i.e. with a lower cetane level than the primary fuel. Moreover, as another non-limiting example, the pilot fuel may be supplied from a source of pilot fuel and the primary fuel may be supplied from a source of primary fuel, wherein the source of pilot fuel is distinct from the source of primary fuel.

The first aspect of the disclosure may seek to improve combustion of the primary fuel, preferably resulting in more complete combustion of the primary fuel. As such, the first aspect of the disclosure may deliver an appropriately high energy output, preferably when using primary fuels which are more sustainable than e.g. fossil diesel fuel. More complete combustion may be indicative of less residuals, which in turn may be beneficial for an exhaust after treatment system provided downstream the internal combustion engine. A technical benefit of the present disclosure may include that the elevated temperature and/or pressure in the combustion chamber during the compression phase will initiate chemical reactions of the pilot fuel which will generate radicals and heat which will initiate the combustion of the primary fuel when it enters the combustion chamber, thereby at least partly resulting in diffusion combustion of the primary fuel. Hence, the pilot fuel will ignite the primary fuel, thereby resulting in combustion of the primary fuel in the combustion chamber, e.g. at least partly resulting in diffusion combustion. By way of example, injecting the pilot fuel into the air intake system instead of e.g. injecting pilot fuel directly into the combustion chamber may imply a less complicated combustion chamber. This may result in a more reliable and robust internal combustion engine. As another example, injecting the pilot fuel into the air intake system instead of e.g. injecting pilot fuel directly into the combustion chamber may imply an improved mixing of the pilot fuel with the air, e.g., so that the fuel/air mixture is more homogenized.

Optionally in some examples, including in at least one preferred example, the pilot fuel will ignite which will initiate the combustion of the primary fuel when it enters the combustion chamber, thereby at least partly resulting in diffusion combustion of the primary fuel.

Optionally in some examples, including in at least one preferred example, the pilot fuel has a higher ignitability than the primary fuel. A technical benefit may include that the pilot fuel will ignite before the primary fuel during the compression phase such that combustion of the primary fuel occurs, such as diffusion combustion of the primary fuel.

Optionally in some examples, including in at least one preferred example, the pilot fuel is diesel (i.e. fossil diesel), bio-diesel or HVO (Hydrotreated Vegetable Oil) diesel. A technical benefit may include that the pilot fuel is a high cetane fuel with high ignitability.

Optionally in some examples, including in at least one preferred example, the primary fuel is any of, or any combination of, the following fuels:
methanol,
ethanol,
hydrogen,
methane, and
ammonia.
   A technical benefit may include that the internal combustion engine uses more sustainable fuels, thereby reducing the environmental impact of the internal combustion engine.

Optionally in some examples, including in at least one preferred example, the main injection of primary fuel is injected by the main fuel injector at a first pressure level and the pilot injection of pilot fuel is injected by the pilot fuel injector at a second pressure level, wherein the first pressure level is higher than the second pressure level. A technical benefit may include improved combustion of the primary fuel.

Optionally in some examples, including in at least one preferred example, the first pressure level is in the range of 100-1500 bar, such as 200-1000 bar or 200-600 bar, and/or the second pressure level is in the range of 5-25 bar, such as 5-20 bar. A technical benefit may include beneficial pressure levels for achieving an efficient combustion with few residuals and high energy output.

Optionally in some examples, including in at least one preferred example, the intake phase is at least partly defined by a time duration from a first time point at which the at least one air intake valve opens the fluid communication between the air intake system and the combustion chamber to a second time point at which the at least one air intake valve closes the fluid communication between the air intake system and the combustion chamber, wherein injecting the pilot fuel into the air intake system by the pilot fuel injector is initiated at an initiation time point during the intake phase which is closer to the second time point than to the first time point. A technical benefit may include that the pilot fuel is injected at a time point which is closer to the end of the intake phase. This may result in reduced consumption of pilot fuel while still at least partly enabling diffusion combustion of the primary fuel. This may also imply a reduced risk of unwanted wall wetting in the air intake system.

Optionally in some examples, including in at least one preferred example, injecting the primary fuel directly into the combustion chamber by the main fuel injector is initiated during the compression phase at a cranking angle from the top dead center which is in the range of −50° to 0°, such as −40° to 0°. By way of example, the cranking angle from the top dead center may be in the range of −20° to 0°, such as −10°. A technical benefit may include a more complete combustion of the primary fuel, e.g., the primary fuel is injected close to a time point when the pilot fuel can initiate the combustion of the primary fuel.

Optionally in some examples, including in at least one preferred example, an energy content of the pilot fuel injected during the intake phase corresponds to 1-25% of the total energy content of the pilot fuel and primary fuel provided into the combustion chamber during the intake phase and the subsequent compression phase, such as 1-10 energy %, 1-5 energy % or 2-5 energy %. A technical benefit may include an efficient combustion of the primary fuel while still using a relatively low amount of pilot fuel. This may imply a reduced environmental impact of the internal combustion engine.

Optionally in some examples, including in at least one preferred example, the internal combustion engine is arranged to be operated in at least a first load mode and a second load mode, wherein during the first load mode a higher torque is subjected to the internal combustion engine than in the second load mode, and wherein injecting the pilot fuel into the air intake system by the pilot fuel injector comprises injecting a lower amount of pilot fuel during the first load mode than during the second load mode. A technical benefit may include that a lower amount of pilot fuel can be used during use of the internal combustion engine. This is since it has been realized that less pilot fuel may be required during the first load mode. For example, at higher loads the temperature and/or the pressure in the combustion chamber will likely be higher, and thereby the primary fuel will more easily be ignited. As such, instead of using e.g. the same amount of pilot fuel for each pilot fuel injection, the pilot fuel injection may be adapted to each load mode.

Optionally in some examples, including in at least one preferred example, the internal combustion engine is arranged to be operated in at least a first temperature state and a second temperature state, wherein during the first temperature state the internal combustion engine has an operating temperature which is lower than an operating temperature in the second temperature state, and wherein injecting the pilot fuel into the air intake system by the pilot fuel injector comprises injecting a higher amount of pilot fuel during the first temperature state than during the second temperature state. A technical benefit may include that a lower amount of pilot fuel can be used during use of the internal combustion engine. This is since it has been realized that less pilot fuel may be used when the operating temperature is higher compared to e.g. when the operating temperature is lower due to a cold condition, for example when an ambient temperature is less than 10° Celsius, such as less than 5°, 0° or −5° Celsius. The operating temperature of the internal combustion engine may refer to one or more of the following: a temperature of coolant fluid for the internal combustion engine, a temperature in the air intake system, a temperature in the combustion chamber, a cylinder wall temperature, an engine block temperature. By way of example, the first temperature state may refer to a cold start condition of the internal combustion engine.

Optionally in some examples, including in at least one preferred example, injecting the primary fuel directly into the combustion chamber by the main fuel injector comprises a first injection in which a first amount of primary fuel is directly injected into the combustion chamber, followed by a second injection in which a second amount of primary fuel is directly injected into the combustion chamber, wherein the first and second injections are individually distinct. A technical benefit may include improved combustion of the primary fuel. For example, a diffusion combustion of the second amount of primary fuel may be initiated by an already initiated combustion of the first amount of primary fuel in the combustion chamber.

Optionally in some examples, including in at least one preferred example, the method further comprises controlling an initiation of the first and second injections by a timer-based and/or crank angle based control. A technical benefit may include a cost-effective, reliable and/or robust control of the injections.

Optionally in some examples, including in at least one preferred example, the second amount of primary fuel is larger than the first amount of primary fuel. A technical benefit may include improved combustion of the primary fuel, e.g. allowing combustion of the lower amount of primary fuel to be initiated before injecting the larger amount of primary fuel. The amount of fuel(s) as discussed herein may refer to a mass amount of fuel.

Optionally in some examples, including in at least one preferred example, the method comprises controlling initiation of the second injection such that the second injection is injected at a time point when a combustion of the first amount of primary fuel is occurring in the combustion chamber. A technical benefit may include improved combustion of the primary fuel. The combustion of the first amount of primary fuel may not necessarily be a diffusion combustion, but additionally or alternatively, it may be a premixed combustion.

Optionally in some examples, including in at least one preferred example, the internal combustion engine is arranged to receive exhaust gas into the combustion chamber from an exhaust gas recirculation system during operation, wherein the method comprises injecting a lower amount of pilot fuel into the air intake system by the pilot fuel injector when the exhaust gas recirculation system has reached an operating state which is indicative of an exhaust gas temperature which is above a threshold temperature as compared to an amount of pilot fuel injected into the air intake system by the pilot fuel injector when the exhaust gas recirculation system is in an operating state which is indicative of an exhaust gas temperature being equal to or below the threshold temperature. A technical benefit may include that less pilot fuel is consumed during use of the internal combustion engine. The threshold temperature may relate to a temperature at which the primary fuel will more easily self-ignite during compression. Hence, less pilot fuel may be required in this operating state of the exhaust gas recirculation system.

According to a second aspect of the disclosure, an internal combustion engine system comprising an internal combustion engine and a control unit is provided. The internal combustion engine comprises:
a cylinder and a piston at least partially accommodated by the cylinder, wherein the piston is arranged to reciprocate within and relative to the cylinder between a top dead center and a bottom dead center, said cylinder and said piston at least partially defining a combustion chamber,
an air intake system arranged to provide air into the combustion chamber,
at least one air intake valve arranged to selectively open and close fluid communication between the air intake system and the combustion chamber,
a main fuel injector arranged to inject a primary fuel directly into the combustion chamber,
a pilot fuel injector arranged to inject a pilot fuel into the air intake system,
   wherein the control unit is configured to:
   during and/or prior to an intake phase when at least air is provided into the combustion chamber from the air intake system while the piston is moving from the top dead center to the bottom dead center, inject a pilot fuel into the air intake system by the pilot fuel injector, and during a compression phase following said intake phase when the piston is moving from the bottom dead center to the top dead center, inject a primary fuel directly into the combustion chamber by the main fuel injector. Advantages and technical benefits of the second aspect of the disclosure are analogous to the advantages and technical benefits of the first aspect of the disclosure.

Optionally in some examples, including in at least one preferred example, the internal combustion engine system is configured such that the main injection of primary fuel is injected by the main fuel injector at a first pressure level and the pilot injection of pilot fuel is injected by the pilot fuel injector at a second pressure level, wherein the first pressure level is higher than the second pressure level.

Optionally in some examples, including in at least one preferred example, the first pressure level is in the range of 100-1500 bar, such as 200-1000 bar or 200-600 bar, and/or the second pressure level is in the range of 5-25 bar, such as 5-20 bar.

Optionally in some examples, including in at least one preferred example, the intake phase is at least partly defined by a time duration from a first time point at which the at least one air intake valve opens the fluid communication between the air intake system and the combustion chamber to a second time point at which the at least one air intake valve closes the fluid communication between the air intake system and the combustion chamber, wherein injecting the pilot fuel into the air intake system by the pilot fuel injector is initiated by the control unit at an initiation time point during the intake phase which is closer to the second time point than to the first time point.

Optionally in some examples, including in at least one preferred example, injecting the primary fuel directly into the combustion chamber by the main fuel injector is initiated by the control unit during the compression phase at a cranking angle from the top dead center which is in the range of −50° to 0°, such as −40° to 0°.

Optionally in some examples, including in at least one preferred example, an energy content of the pilot fuel injected during the intake phase corresponds to 1-25% of the total energy content of the pilot fuel and primary fuel provided into the combustion chamber during the intake phase and the subsequent compression phase, such as 1-10 energy %, 1-5 energy % or 2-5 energy %.

Optionally in some examples, including in at least one preferred example, the internal combustion engine is arranged to be operated in at least a first load mode and a second load mode, wherein during the first load mode a higher torque is subjected to the internal combustion engine than in the second load mode, and wherein injecting the pilot fuel into the air intake system by the pilot fuel injector comprises injecting a lower amount of pilot fuel during the first load mode than during the second load mode.

Optionally in some examples, including in at least one preferred example, the internal combustion engine is arranged to be operated in at least a first temperature state and a second temperature state, wherein during the first temperature state the internal combustion engine has an operating temperature which is lower than an operating temperature in the second temperature state, and wherein injecting the pilot fuel into the air intake system by the pilot fuel injector comprises injecting a higher amount of pilot fuel during the first temperature state than during the second temperature state.

Optionally in some examples, including in at least one preferred example, injecting the primary fuel directly into the combustion chamber by the main fuel injector comprises a first injection in which a first amount of primary fuel is directly injected into the combustion chamber, followed a second injection in which a second amount of primary fuel is directly injected into the combustion chamber, wherein the first and second injections are individually distinct.

Optionally in some examples, including in at least one preferred example, the control unit is further configured to control an initiation of the first and second injections by a timer-based and/or crank-angle based control.

Optionally in some examples, including in at least one preferred example, the second amount of primary fuel is larger than the first amount of primary fuel.

Optionally in some examples, including in at least one preferred example, the control unit is configured to control initiation of the second injection such that the second injection is injected at a time point when a combustion of the first amount of primary fuel is occurring in the combustion chamber.

Optionally in some examples, including in at least one preferred example, the internal combustion engine is arranged to receive exhaust gas into the combustion chamber from an exhaust gas recirculation system during operation, wherein the internal combustion engine system is configured to inject a lower amount of pilot fuel into the air intake system by the pilot fuel injector when the exhaust gas recirculation system has reached an operating state which is indicative of an exhaust gas temperature which is above a threshold temperature as compared to an amount of pilot fuel injected to into the air intake system by the pilot fuel injector when the exhaust gas recirculation system is in an operating state which is indicative of an exhaust gas temperature being equal to or below the threshold temperature.

According to a third aspect of the disclosure, a vehicle comprising the internal combustion engine system according to any one of the examples of the second aspect of the disclosure is provided. The vehicle may be any type of vehicle, such as a marine vessel, e.g. a boat or a ship, a truck, a bus, a passenger car, and construction equipment, such as a wheel loader or an excavator.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary vehicle according to an example.

FIG. 2 is an exemplary internal combustion engine system according to an example.

FIG. 3 is an exemplary flowchart of a method according to an example.

FIG. 4 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

An aim of the present disclosure is to provide an improved method and internal combustion engine system which at least partly alleviates one or more drawbacks of the prior art. For example, an aim of the present disclosure is to achieve an improved and more efficient combustion of a primary fuel. The primary fuel is preferably a sustainable fuel, e.g. a fuel which is more sustainable than diesel or gasoline fossil fuel.

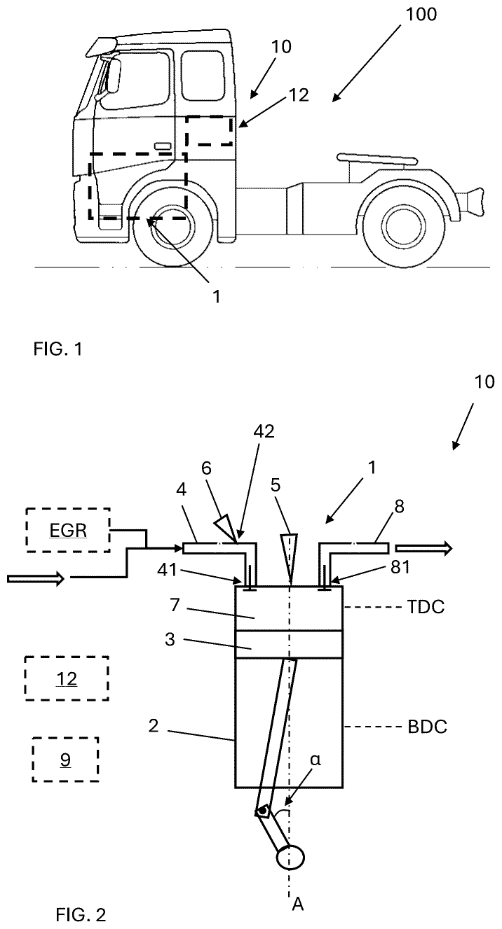

FIG. 1 is an exemplary vehicle 100 in a side view according to an example. The vehicle 100 is in this example a truck, and more specifically a towing truck for towing one or more trailers (not shown). It shall however be noted that any other vehicle may be used, such as a marine vessel, a bus, a passenger car, etc. The vehicle 100 comprises an internal combustion engine system 10. The internal combustion engine system 10 comprises an internal combustion engine 1 and a control unit 12. The control unit 12 may be an electronic control unit, such as an MECU (motor electronic control unit). The internal combustion engine 1 is arranged to drive the vehicle 100.

FIG. 2 is a schematic view of an internal combustion engine system 10 according to an example. For example, the internal combustion engine system 10 in FIG. 2 may be the internal combustion engine system 10 in FIG. 1.

The internal combustion engine system 10 comprises an internal combustion engine 1. It may also as shown comprise a control unit 12 (indicated by a dashed box). The control unit 12 is preferably arranged to control operation of the internal combustion engine 1, i.e. according to examples of the method as disclosed herein.

The internal combustion engine 1 comprises a cylinder 2 and a piston 3 at least partially accommodated by the cylinder 2. The piston 3 is arranged to reciprocate within and relative to the cylinder 2 between a top dead center TDC and a bottom dead center BDC. The cylinder 2 and the piston 3 at least partially define a combustion chamber 7. As shown, the piston 3 is preferably arranged to reciprocate along a center axis A of the cylinder 2.

In the shown example, one cylinder 2 is depicted. It shall however be noted that the internal combustion engine typically comprises a plurality of cylinders, such as 4, 6, 8 or more cylinders.

The internal combustion engine 1 further comprises an air intake system 4 arranged to provide air into the combustion chamber 7. The air intake system 4 may for example be an air intake manifold of the internal combustion engine 1.

The internal combustion engine 1 further comprises at least one air intake valve 41 arranged to selectively open and close fluid communication between the air intake system 4 and the combustion chamber 7. The internal combustion engine 1 may as shown also comprise at least one outlet valve 81 for selectively open and close fluid communication between the combustion chamber 7 and an exhaust gas outlet system 8. The exhaust gas outlet system 8 may be fluidly connected to an exhaust gas treatment system (not shown) for treating the exhaust gas before being emitted to an external environment.

The internal combustion engine 1 further comprises a main fuel injector 5 arranged to inject a primary fuel directly into the combustion chamber 7. The main fuel injector 5 may be arranged to inject a liquid fuel and/or a gaseous fuel into the combustion chamber 7.

The internal combustion engine 1 further comprises a pilot fuel injector 6 arranged to inject a pilot fuel into the air intake system 4. The air intake system 4 preferably comprises an opening 42 through which the pilot fuel injector 6 is arranged to inject a pilot fuel into the air intake system 4. The pilot fuel injector 6 may be arranged to inject a liquid fuel and/or a gaseous fuel into the air intake system 4.

As shown in FIG. 2, the internal combustion engine 1 may be arranged to receive exhaust gas into the combustion chamber 7 from an exhaust gas recirculation system EGR during operation. In the shown example, exhaust gas is arranged to be provided into the air intake system 4 by the EGR.

The internal combustion engine system 10 may further comprise a fuel source 9 of primary fuel and/or pilot fuel. Accordingly, the fuel source 9 may be adapted to separately accommodate primary fuel and pilot fuel, such as by two separate fuel tanks. The fuel source 9 is fluidly connected to the main injector 5 and/or to the pilot fuel injector 6.

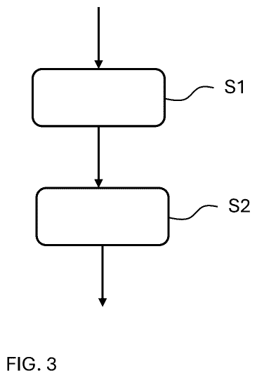

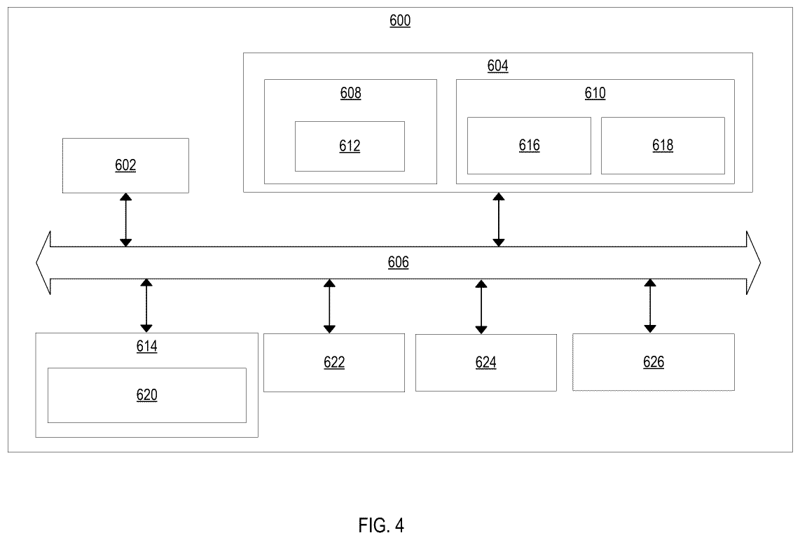

FIG. 3 is a flowchart of a method for operating an internal combustion engine 1 as e.g. shown in FIG. 2.

The method comprises, during and/or prior to an intake phase when at least air is provided into the combustion chamber 7 from the air intake system 4 while the piston 3 is moving from the top dead center TDC to the bottom dead center BDC, injecting S1 a pilot fuel into the air intake system 4 by the pilot fuel injector 6. Accordingly, during the intake phase, the at least one valve 41 is open such that air and/or exhaust gas from the EGR can enter the combustion chamber 7. The pilot fuel is preferably injected during the intake phase, but may additionally or alternatively be injected prior to the intake phase, such as before the at least one valve 41 has opened the fluid communication with the combustion chamber 7. However, to reduce the risk of wall wetting in the air intake system 4, pilot fuel is preferably injected during the intake phase.

The method further comprises:

during a compression phase following said intake phase when the piston 3 is moving from the bottom dead center BDC to the top dead center TDC, injecting S2 a primary fuel directly into the combustion chamber 7 by the main fuel injector 5. During the compression phase the at least one air intake valve 41 is preferably closed. The at least one outlet valve 81 is also preferably closed during the compression phase until it opens for letting out exhaust gas to the exhaust gas outlet system 8, for instance during a subsequent exhaust phase.

According to the present disclosure, the elevated temperature and/or pressure in the combustion chamber 7 during the compression phase will initiate chemical reactions of the pilot fuel which will generate radicals and heat which will initiate the combustion of the primary fuel when it enters the combustion chamber 7, thereby at least partly resulting in diffusion combustion of the primary fuel. Hence, the pilot fuel will ignite the primary fuel, thereby at least partly resulting in diffusion combustion of the primary fuel in the combustion chamber. By way of example, injecting the pilot fuel into the air intake system 4 instead of e.g. injecting pilot fuel directly into the combustion chamber 7 may imply a less complicated combustion chamber 7. This may result in a more reliable and robust internal combustion engine 1. By way of example, the pilot fuel will ignite which will initiate the combustion of the primary fuel when it enters the combustion chamber 7, thereby at least partly resulting in diffusion combustion of the primary fuel.

The pilot fuel preferably has a higher ignitability than the primary fuel. The pilot fuel may be diesel, bio-diesel or HVO diesel. It may also be any mixture of the aforementioned fuels. The pilot fuel is preferably a fuel with high cetane level compared to the primary fuel.

The primary fuel may be any of, or any combination of, the following fuels: methanol, ethanol, hydrogen, methane, and ammonia. A combination of the fuels may also be referred to as a mixture of the fuels. For example, the mixture may be a methane and hydrogen mixture, or an ammonia and hydrogen mixture. The primary fuel may hence be a fuel with a lower cetane level than the pilot fuel.

By way of example, the pilot fuel may be diesel and the primary fuel may be methanol. It has been realized that using diesel as pilot fuel and methanol as primary fuel in an internal combustion engine as disclosed herein may improve the combustion of the primary fuel, wherein the primary fuel is at least partly undergoing diffusion combustion which is at least partly initiated by the pilot fuel. Hence, a more sustainable fuel will be combusted in an efficient manner, which also may result in less residuals in the exhaust gas. It has further been realized that when using methanol as the primary fuel, a longer injection duration may be allowed as compared to other fuels, e.g. diesel where soot formation may increase with an increased injection duration.

The main injection of primary fuel may be injected by the main fuel injector 5 at a first pressure level and the pilot injection of pilot fuel may be injected by the pilot fuel injector 6 at a second pressure level, wherein the first pressure level is higher than the second pressure level. The first pressure level may be in the range of 100-1500 bar, such as 200-1000 bar or 200-600 bar, and/or the second pressure level may be in the range of 5-25 bar, such as 5-20 bar. Even though the first pressure level may be higher than the second pressure level, the first pressure level may be lower as compared to a pressure level if injecting diesel as primary fuel instead of injecting the above mentioned more sustainable primary fuels.

The intake phase may at least partly be defined by a time duration from a first time point at which the at least one air intake valve 41 opens the fluid communication between the air intake system 4 and the combustion chamber 7 to a second time point at which the at least one air intake valve 4 closes the fluid communication between the air intake system 4 and the combustion chamber 7. Injecting the pilot fuel into the air intake system 4 by the pilot fuel injector 6 may be initiated at an initiation time point during the intake phase which is closer to the second time point than to the first time point.

Purely by way of example, the internal combustion engine 1 may be configured to operate according to a Diesel cycle.

Injecting the primary fuel directly into the combustion chamber 7 by the main fuel injector 5 may be initiated during the compression phase at a cranking angle α from the top dead center TDC which is in the range of −50° to 0°, such as −40° to 0°. By way of example, the cranking angle α from the top dead center TDC may be in the range of −20° to 0°, such as −10°. In the shown example, the cranking angle α from the top dead center TDC is measured with respect to the center axis A.

An energy content of the pilot fuel injected during the intake phase may correspond to 1-25% of the total energy content of the pilot fuel and primary fuel provided into the combustion chamber 7 during the intake phase and the subsequent compression phase, such as 1-10 energy %, 1-5 energy % or 2-5 energy %.

The internal combustion engine 1 may be arranged to be operated in at least a first load mode and a second load mode, wherein during the first load mode a higher torque is subjected to the internal combustion engine 1 than in the second load mode, and wherein injecting the pilot fuel into the air intake system 4 by the pilot fuel injector 6 may comprise injecting a lower amount of pilot fuel during the first load mode than during the second load mode. Additionally or alternatively, the internal combustion engine 1 may be arranged to be operated in at least a first power mode and a second power mode, wherein during the first power mode a higher power is provided by the internal combustion engine 1 than in the second power mode, and wherein injecting the pilot fuel into the air intake system 4 by the pilot fuel injector 6 may comprise injecting a lower amount of pilot fuel during the first power mode than during the second power mode.

The internal combustion engine 1 may be arranged to be operated in at least a first temperature state and a second temperature state, wherein during the first temperature state the internal combustion engine 1 has an operating temperature which is lower than an operating temperature in the second temperature state, and wherein injecting the pilot fuel into the air intake system 4 by the pilot fuel injector 6 comprises injecting a higher amount of pilot fuel during the first temperature state than during the second temperature state. The operating temperature of the internal combustion engine 1 may refer to one or more of the following: a temperature of coolant fluid for the internal combustion engine 1, a temperature in the air intake system 4, a temperature in the combustion chamber 7, a cylinder wall temperature, an engine block temperature. By way of example, the first temperature state may refer to a cold start condition of the internal combustion engine 1, such as when an ambient temperature is less than 10° Celsius, such as less than 5°, 0° or −5° Celsius.

Injecting the primary fuel directly into the combustion chamber 7 by the main fuel injector 5 may comprise a first injection in which a first amount of primary fuel is directly injected into the combustion chamber 7, followed by a second injection in which a second amount of primary fuel is directly injected into the combustion chamber 7, wherein the first and second injections are individually distinct.

The method may further comprise controlling an initiation of the first and second injections by a timer-based and/or crank angle based control.

Preferably, the second amount of primary fuel is larger than the first amount of primary fuel. For example, the first amount of primary fuel may correspond to less than 20 energy % of the total amount of primary fuel injected during the compression phase, such as less than 15 energy % or less than 10 energy % of the total amount of primary fuel injected during the compression phase.

The method may comprise controlling initiation of the second injection such that the second injection is injected at a time point when a combustion of the first amount of primary fuel is occurring in the combustion chamber 7.

The method may further comprises injecting a lower amount of pilot fuel into the air intake system 4 by the pilot fuel injector 6 when the exhaust gas recirculation system EGR has reached an operating state which is indicative of an exhaust gas temperature which is above a threshold temperature as compared to an amount of pilot fuel injected into the air intake system 4 by the pilot fuel injector 6 when the exhaust gas recirculation system EGR is in an operating state which is indicative of an exhaust gas temperature being equal to or below the threshold temperature.

As mentioned in the above, the control unit 12 may be configured to control operation of the internal combustion engine 1 according to examples of the method as disclosed herein.

FIG. 4 is a schematic diagram of a computer system 600 for implementing examples disclosed herein. The computer system XX00 is adapted to execute instructions from a computer-readable medium to perform these and/or any of the functions or processing described herein. The computer system 600 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include processing circuitry 602 (e.g., processing circuitry including one or more processor devices or control units), a memory 604, and a system bus 606. The computer system 600 may include at least one computing device having the processing circuitry 602. The system bus 606 provides an interface for system components including, but not limited to, the memory 604 and the processing circuitry 602. The processing circuitry 602 may include any number of hardware components for conducting data or signal processing or for executing computer code stored in memory 604. The processing circuitry 602 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 602 may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the processing circuitry 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with processing circuitry 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program 620 stored on a transitory or non-transitory computer-usable or computer-readable storage medium (e.g., single medium or multiple media), such as the storage device 614, which includes complex programming instructions (e.g., complex computer-readable program code) to cause the processing circuitry 602 to carry out actions described herein. Thus, the computer-readable program code of the computer program 620 can comprise software instructions for implementing the functionality of the examples described herein when executed by the processing circuitry 602. In some examples, the storage device 614 may be a computer program product (e.g., readable storage medium) storing the computer program 620 thereon, where at least a portion of a computer program 620 may be loadable (e.g., into a processor) for implementing the functionality of the examples described herein when executed by the processing circuitry 602. The processing circuitry 602 may serve as a controller or control system for the computer system 600 that is to implement the functionality described herein.

The computer system 600 may include an input device interface 622 configured to receive input and selections to be communicated to the computer system XX00 when executing instructions, such as from a keyboard, mouse, touch-sensitive surface, etc. Such input devices may be connected to the processing circuitry 602 through the input device interface 622 coupled to the system bus 606 but can be connected through other interfaces, such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may include a communications interface 626 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

In the below, possible features and feature combinations of the present disclosure are presented as a list of Examples.
Example 1: A method for operating an internal combustion engine (1), the internal combustion engine (1) comprising:
a cylinder (2) and a piston (3) at least partially accommodated by the cylinder (2), wherein the piston (3) is arranged to reciprocate within and relative to the cylinder (2) between a top dead center (TDC) and a bottom dead center (BDC), said cylinder and said piston at least partially defining a combustion chamber (7),
an air intake system (4) arranged to provide air into the combustion chamber (7),
at least one air intake valve (41) arranged to selectively open and close fluid communication between the air intake system (4) and the combustion chamber (7),
a main fuel injector (5) arranged to inject a primary fuel directly into the combustion chamber (7),
a pilot fuel injector (6) arranged to inject a pilot fuel into the air intake system (4), wherein the method comprises:
   during and/or prior to an intake phase when at least air is provided into the combustion chamber (7) from the air intake system (4) while the piston (3) is moving from the top dead center (TDC) to the bottom dead center (BDC), injecting (S1) a pilot fuel into the air intake system (4) by the pilot fuel injector (6), and
   during a compression phase following said intake phase when the piston (3) is moving from the bottom dead center (BDC) to the top dead center (TDC), injecting (S2) a primary fuel directly into the combustion chamber (7) by the main fuel injector (5).
Example 2: The method according to Example 1, wherein the pilot fuel has a higher ignitability than the primary fuel.
Example 3: The method according to any one of the preceding Examples, wherein the pilot fuel is diesel, bio-diesel or HVO diesel.
Example 4: The method according to any one of the preceding Examples, wherein the primary fuel is any of, or any combination of, the following fuels:
methanol,
ethanol,
hydrogen,
methane, and
ammonia.
Example 5: The method according to any one of the preceding Examples, wherein the main injection of primary fuel is injected by the main fuel injector (5) at a first pressure level and the pilot injection of pilot fuel is injected by the pilot fuel injector (6) at a second pressure level, wherein the first pressure level is higher than the second pressure level.
Example 6: The method according to Example 5, wherein the first pressure level is in the range of 100-1500 bar, such as 200-1000 bar or 200-600, and/or the second pressure level is in the range of 5-25 bar, such as 5-20 bar.
Example 7: The method according to any one of the preceding Examples, wherein the intake phase is at least partly defined by a time duration from a first time point at which the at least one air intake valve (41) opens the fluid communication between the air intake system (4) and the combustion chamber (7) to a second time point at which the at least one air intake valve (4) closes the fluid communication between the air intake system (4) and the combustion chamber (7), wherein injecting the pilot fuel into the air intake system (4) by the pilot fuel injector (6) is initiated at an initiation time point during the intake phase which is closer to the second time point than to the first time point.
Example 8: The method according to any one of the preceding Examples, wherein injecting the primary fuel directly into the combustion chamber (7) by the main fuel injector (5) is initiated during the compression phase at a cranking angle (α) from the top dead center (TDC) which is in the range of −50° to 0°, such as −40° to 0°.
Example 9: The method according to any one of the preceding Examples, wherein an energy content of the pilot fuel injected during the intake phase corresponds to 1-25% of the total energy content of the pilot fuel and primary fuel provided into the combustion chamber (7) during the intake phase and the subsequent compression phase, such as 1-10 energy %, 1-5 energy % or 2-5 energy %.
Example 10: The method according to any one of the preceding Examples, wherein the internal combustion engine (1) is arranged to be operated in at least a first load mode and a second load mode, wherein during the first load mode a higher torque is subjected to the internal combustion engine (1) than in the second load mode, and wherein injecting the pilot fuel into the air intake system (4) by the pilot fuel injector (6) comprises injecting a lower amount of pilot fuel during the first load mode than during the second load mode.
Example 11: The method according to any one of the preceding Examples, wherein the internal combustion engine (1) is arranged to be operated in at least a first temperature state and a second temperature state, wherein during the first temperature state the internal combustion engine (1) has an operating temperature which is lower than an operating temperature in the second temperature state, and wherein injecting the pilot fuel into the air intake system (4) by the pilot fuel injector (6) comprises injecting a higher amount of pilot fuel during the first temperature state than during the second temperature state.
Example 12: The method according to any one of the preceding Examples, wherein injecting the primary fuel directly into the combustion chamber (7) by the main fuel injector (5) comprises a first injection in which a first amount of primary fuel is directly injected into the combustion chamber (7), followed by a second injection in which a second amount of primary fuel is directly injected into the combustion chamber (7), wherein the first and second injections are individually distinct.
Example 13: The method according to Example 12, further comprising controlling an initiation of the first and second injections by a timer-based and/or crank angle based control.
Example 14: The method according to any one of Examples 12 or 13, wherein the second amount of primary fuel is larger than the first amount of primary fuel.
Example 15: The method according to any one of Examples 12-14, wherein the method comprises controlling initiation of the second injection such that the second injection is injected at a time point when a combustion of the first amount of primary fuel is occurring in the combustion chamber (7).
Example 16: The method according to any one of the preceding Examples, wherein the internal combustion engine (1) is arranged to receive exhaust gas into the combustion chamber (7) from an exhaust gas recirculation system (EGR) during operation, wherein the method comprises injecting a lower amount of pilot fuel into the air intake system (4) by the pilot fuel injector (6) when the exhaust gas recirculation system (EGR) has reached an operating state which is indicative of an exhaust gas temperature which is above a threshold temperature as compared to an amount of pilot fuel injected into the air intake system (4) by the pilot fuel injector (6) when the exhaust gas recirculation system (EGR) is in an operating state which is indicative of an exhaust gas temperature being equal to or below the threshold temperature.
Example 17: An internal combustion engine system (10) comprising an internal combustion engine (1) and a control unit (12), the internal combustion engine (1) comprising:
a cylinder (2) and a piston (3) at least partially accommodated by the cylinder (2), wherein the piston (3) is arranged to reciprocate within and relative to the cylinder (2) between a top dead center (TDC) and a bottom dead center (BDC), said cylinder (2) and said piston (3) at least partially defining a combustion chamber (7),
an air intake system (4) arranged to provide air into the combustion chamber (7),
at least one air intake valve (41) arranged to selectively open and close fluid communication between the air intake system (7) and the combustion chamber (7),
a main fuel injector (5) arranged to inject a primary fuel directly into the combustion chamber (7),
a pilot fuel injector (6) arranged to inject a pilot fuel into the air intake system (4), wherein the control unit (12) is configured to:
   during and/or prior to an intake phase when at least air is provided into the combustion chamber (7) from the air intake system (4) while the piston (3) is moving from the top dead center (TDC) to the bottom dead center (BDC), inject a pilot fuel into the air intake system (4) by the pilot fuel injector (6), and
   during a compression phase following said intake phase when the piston (3) is moving from the bottom dead center (BDC) to the top dead center (TDC), inject a primary fuel directly into the combustion chamber (7) by the main fuel injector (5).
Example 18: The internal combustion engine system (10) according to Example 17, wherein the internal combustion engine system (10) is configured such that the main injection of primary fuel is injected by the main fuel injector (5) at a first pressure level and the pilot injection of pilot fuel is injected by the pilot fuel injector (6) at a second pressure level, wherein the first pressure level is higher than the second pressure level.
Example 19: The internal combustion engine system (10) according to Example 18, wherein the first pressure level is in the range of 100-1500 bar, such as 200-1000 bar or 200-600 bar, and/or the second pressure level is in the range of 5-25 bar, such as 5-20 bar.
Example 20: The internal combustion engine system (10) according to any one of Examples 17-19, wherein the intake phase is at least partly defined by a time duration from a first time point at which the at least one air intake valve (41) opens the fluid communication between the air intake system (4) and the combustion chamber (7) to a second time point at which the at least one air intake valve (41) closes the fluid communication between the air intake system (4) and the combustion chamber (7), wherein injecting the pilot fuel into the air intake system (4) by the pilot fuel injector (6) is initiated by the control unit (12) at an initiation time point during the intake phase which is closer to the second time point than to the first time point.
Example 21: The internal combustion engine system (10) according to any one of Examples 17-20, wherein injecting the primary fuel directly into the combustion chamber (7) by the main fuel injector (5) is initiated by the control unit (12) during the compression phase at a cranking angle (α) from the top dead center (TDC) which is in the range of −50° to 0°, such as −40° to 0°.
Example 22: The internal combustion engine system (10) according to any one of Examples 17-21, wherein an energy content of the pilot fuel injected during the intake phase corresponds to 1-25% of the total energy content of the pilot fuel and primary fuel provided into the combustion chamber (7) during the intake phase and the subsequent compression phase, such as 1-10 energy %, 1-5 energy % or 2-5 energy %.
Example 23: The internal combustion engine system (10) according to any one of Examples 17-22, wherein the internal combustion engine (1) is arranged to be operated in at least a first load mode and a second load mode, wherein during the first load mode a higher torque is subjected to the internal combustion engine (1) than in the second load mode, and wherein injecting the pilot fuel into the air intake system (4) by the pilot fuel injector (6) comprises injecting a lower amount of pilot fuel during the first load mode than during the second load mode.
Example 24: The internal combustion engine system (10) according to any one of Examples 17-23, wherein the internal combustion engine (1) is arranged to be operated in at least a first temperature state and a second temperature state, wherein during the first temperature state the internal combustion engine (1) has an operating temperature which is lower than an operating temperature in the second temperature state, and wherein injecting the pilot fuel into the air intake system (4) by the pilot fuel injector (6) comprises injecting a higher amount of pilot fuel during the first temperature state than during the second temperature state.
Example 25: The internal combustion engine system (10) according to any one of Examples 17-24, wherein injecting the primary fuel directly into the combustion chamber (7) by the main fuel injector (5) comprises a first injection in which a first amount of primary fuel is directly injected into the combustion chamber (7), followed a second injection in which a second amount of primary fuel is directly injected into the combustion chamber (7), wherein the first and second injections are individually distinct.
Example 26: The internal combustion engine system (10) according to Example 25, wherein the control unit (12) is further configured to control an initiation of the first and second injections by a timer-based and/or crank-angle based control.
Example 27: The internal combustion engine system (10) according to any one of Examples 25 or 26, wherein the second amount of primary fuel is larger than the first amount of primary fuel.
Example 28: The internal combustion engine system (10) according to any one of Examples 25-27, wherein the control unit (12) is configured to control initiation of the second injection such that the second injection is injected at a time point when a combustion of the first amount of primary fuel is occurring in the combustion chamber (7).
Example 29: The internal combustion engine system (10) according to any one of Examples 17-28, wherein the internal combustion engine (1) is arranged to receive exhaust gas into the combustion chamber (7) from an exhaust gas recirculation system (EGR) during operation, wherein the internal combustion engine system (10) is configured to inject a lower amount of pilot fuel into the air intake system (4) by the pilot fuel injector (6) when the exhaust gas recirculation system (EGR) has reached an operating state which is indicative of an exhaust gas temperature which is above a threshold temperature as compared to an amount of pilot fuel injected to into the air intake system (4) by the pilot fuel injector (6) when the exhaust gas recirculation system (EGR) is in an operating state which is indicative of an exhaust gas temperature being equal to or below the threshold temperature.
Example 30: A vehicle (100) comprising the internal combustion engine system (10) according to any one of Examples 17-29.

The terminology used herein is for the purpose of describing particular aspects only and is not intended to be limiting of the disclosure. As used herein, the singular forms “a”, “an”, and “the” are intended to include the plural forms as well, unless the context clearly indicates otherwise. As used herein, the term “and/or” includes any and all combinations of one or more of the associated listed items. It will be further understood that the terms “comprises”, “comprising”, “includes”, and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A method for operating an internal combustion engine, the internal combustion engine comprising:
a cylinder and a piston at least partially accommodated by the cylinder, wherein the piston is arranged to reciprocate within and relative to the cylinder between a top dead center and a bottom dead center, said cylinder and said piston at least partially defining a combustion chamber,
an air intake system arranged to provide air into the combustion chamber,
at least one air intake valve arranged to selectively open and close fluid communication between the air intake system and the combustion chamber,
a main fuel injector arranged to inject a primary fuel directly into the combustion chamber,
a pilot fuel injector arranged to inject a pilot fuel into the air intake system,
wherein the method comprises:
during and/or prior to an intake phase when at least air is provided into the combustion chamber from the air intake system while the piston is moving from the top dead center to the bottom dead center, injecting a pilot fuel into the air intake system by the pilot fuel injector, and
during a compression phase following said intake phase when the piston is moving from the bottom dead center to the top dead center, injecting a primary fuel directly into the combustion chamber by the main fuel injector.

2. The method according to claim 1, wherein the pilot fuel has a higher ignitability than the primary fuel.

3. The method according to claim 1, wherein the pilot fuel is diesel, bio-diesel or HVO diesel.

4. The method according to claim 1, wherein the primary fuel is any of, or any combination of, the following fuels:
methanol,
ethanol,
hydrogen,
methane, and
ammonia.

5. The method according to claim 1, wherein the main injection of primary fuel is injected by said main fuel injector at a first pressure level and the pilot injection of pilot fuel is injected by said pilot fuel injector at a second pressure level, wherein the first pressure level is higher than the second pressure level.

6. The method according to claim 1, wherein the intake phase is at least partly defined by a time duration from a first time point at which the at least one air intake valve opens the fluid communication between the air intake system and the combustion chamber to a second time point at which the at least one air intake valve closes the fluid communication between the air intake system and the combustion chamber, wherein injecting the pilot fuel into the air intake system by the pilot fuel injector is initiated at an initiation time point during the intake phase which is closer to the second time point than to the first time point.

7. The method according to claim 1, wherein injecting the primary fuel directly into the combustion chamber by the main fuel injector is initiated during the compression phase at a cranking angle from the top dead center which is in the range of −50° to 0°.

8. The method according to claim 1, wherein an energy content of the pilot fuel injected during the intake phase corresponds to 1-25% of the total energy content of the pilot fuel and primary fuel provided into the combustion chamber during the intake phase and the subsequent compression phase.

9. The method according to claim 1, wherein the internal combustion engine is arranged to be operated in at least a first load mode and a second load mode, wherein during the first load mode a higher torque is subjected to the internal combustion engine than in the second load mode, and wherein injecting the pilot fuel into the air intake system by the pilot fuel injector comprises injecting a lower amount of pilot fuel during the first load mode than during the second load mode.

10. The method according to claim 1, wherein the internal combustion engine is arranged to be operated in at least a first temperature state and a second temperature state, wherein during the first temperature state the internal combustion engine has an operating temperature which is lower than an operating temperature in the second temperature state, and wherein injecting the pilot fuel into the air intake system by the pilot fuel injector comprises injecting a higher amount of pilot fuel during the first temperature state than during the second temperature state.

11. The method according to claim 1, wherein injecting the primary fuel directly into the combustion chamber by the main fuel injector comprises a first injection in which a first amount of primary fuel is directly injected into the combustion chamber, followed by a second injection in which a second amount of primary fuel is directly injected into the combustion chamber, wherein the first and second injections are individually distinct.

12. The method according to claim 11, wherein the method comprises controlling initiation of the second injection such that the second injection is injected at a time point when a combustion of the first amount of primary fuel is occurring in the combustion chamber.

13. The method according to claim 1, wherein the internal combustion engine is arranged to receive exhaust gas into the combustion chamber from an exhaust gas recirculation system during operation, wherein the method comprises injecting a lower amount of pilot fuel into the air intake system by the pilot fuel injector when the exhaust gas recirculation system has reached an operating state which is indicative of an exhaust gas temperature which is above a threshold temperature as compared to an amount of pilot fuel injected into the air intake system by the pilot fuel injector when the exhaust gas recirculation system is in an operating state which is indicative of an exhaust gas temperature being equal to or below the threshold temperature.

14. An internal combustion engine system comprising an internal combustion engine and a control unit, the internal combustion engine comprising:
a cylinder and a piston at least partially accommodated by the cylinder, wherein the piston is arranged to reciprocate within and relative to the cylinder between a top dead center and a bottom dead center, said cylinder and said piston at least partially defining a combustion chamber,
an air intake system arranged to provide air into the combustion chamber,
at least one air intake valve arranged to selectively open and close fluid communication between the air intake system and the combustion chamber,
a main fuel injector arranged to inject a primary fuel directly into the combustion chamber,
a pilot fuel injector arranged to inject a pilot fuel into the air intake system,
wherein the control unit is configured to:
during and/or prior to an intake phase when at least air is provided into the combustion chamber from the air intake system while the piston is moving from the top dead center to the bottom dead center, inject a pilot fuel into the air intake system by the pilot fuel injector, and during a compression phase following said intake phase when the piston is moving from the bottom dead center to the top dead center, inject a primary fuel directly into the combustion chamber by the main fuel injector.

15. A vehicle comprising the internal combustion engine system according to claim 14.

16. The method according to claim 14, wherein the internal combustion engine is arranged to receive exhaust gas into the combustion chamber from an exhaust gas recirculation system during operation, wherein the method comprises injecting a lower amount of pilot fuel into the air intake system by the pilot fuel injector when the exhaust gas recirculation system has reached an operating state which is indicative of an exhaust gas temperature which is above a threshold temperature as compared to an amount of pilot fuel injected into the air intake system by the pilot fuel injector when the exhaust gas recirculation system is in an operating state which is indicative of an exhaust gas temperature being equal to or below the threshold temperature.

17. An internal combustion engine system comprising an internal combustion engine and a control unit, the internal combustion engine comprising:
a cylinder and a piston at least partially accommodated by the cylinder, wherein the piston is arranged to reciprocate within and relative to the cylinder between a top dead center and a bottom dead center, said cylinder and said piston at least partially defining a combustion chamber,
an air intake system arranged to provide air into the combustion chamber,
at least one air intake valve arranged to selectively open and close fluid communication between the air intake system and the combustion chamber,
a main fuel injector arranged to inject a primary fuel directly into the combustion chamber,
a pilot fuel injector arranged to inject a pilot fuel into the air intake system,
wherein the control unit is configured to:
during and/or prior to an intake phase when at least air is provided into the combustion chamber from the air intake system while the piston is moving from the top dead center to the bottom dead center, inject a pilot fuel into the air intake system by the pilot fuel injector, and during a compression phase following said intake phase when the piston is moving from the bottom dead center to the top dead center, inject a primary fuel directly into the combustion chamber by the main fuel injector.

18. The internal combustion engine system according to claim 17, wherein the internal combustion engine system is configured such that the main injection of primary fuel is injected by the main fuel injector at a first pressure level and the pilot injection of pilot fuel is injected by the pilot fuel injector at a second pressure level, wherein the first pressure level is higher than the second pressure level.

19. The internal combustion engine system according to claim 18, wherein the first pressure level is in the range of 100-1500 bar.

20. The internal combustion engine system according to claim 17, wherein the intake phase is at least partly defined by a time duration from a first time point at which the at least one air intake valve opens the fluid communication between the air intake system and the combustion chamber to a second time point at which the at least one air intake valve closes the fluid communication between the air intake system and the combustion chamber, wherein injecting the pilot fuel into the air intake system by the pilot fuel injector is initiated by the control unit at an initiation time point during the intake phase which is closer to the second time point than to the first time point.
